(19) United States
(12) Patent Application Publication
(10) Pub. No.: US 2021/0108025 A1
(43) Pub. Date: Apr. 15, 2021

(54) EPOXY RESIN COMPOSITION

(71) Applicant: NAMICS CORPORATION, Niigata-shi, Niigata (JP)

(72) Inventors: Yohei UESUGI, Niigata-shi, Niigata (JP); Kazuki IWAYA, Niigata-shi, Niigata (JP)

(73) Assignee: NAMICS CORPORATION, Niigata-shi, Niigata (JP)

(21) Appl. No.: 16/970,419

(22) PCT Filed: Feb. 20, 2019
(86) PCT No.: PCT/JP2019/006298

§ 371 Date: Aug. 17, 2020

(30) Foreign Application Priority Data
Feb. 21, 2018 (JP) 2018-029036

(51) Int. Cl. C08G 59/68; C09J 163/00; C08L 63/00; C08G 59/66; C08G 59/22

(52) U.S. Cl. CPC C08G 59/687; C09J 163/00; C08L 63/00; C08L 2205/025; C08G 59/226; C08L 2205/03; C08G 59/66

(57) ABSTRACT

An epoxy resin composition includes at least one thiol-based curing agent, a main epoxy resin, and a curing catalyst. The at least one thiol-based curing agent includes a non-hydrolyzable polyfunctional thiol compound having at least one hydroxyl group and/or urea bond. The main epoxy resin is at least one main aliphatic polyfunctional epoxy resin selected from a polyethylene glycol diglycidyl ether, a cyclohexane-based diglycidyl ether, and a dicyclopentadiene-based diglycidyl ether. The epoxy resin composition has a viscosity at 25° C. of 0.05 Pa·s or higher and 3 Pa·s or lower

### TECHNICAL FIELD

The present invention relates to an epoxy resin composition, a sealing material comprising the same, a cured product obtained by curing the same, and an electronic component comprising the cured product,

### BACKGROUND ART

Currently, an adhesive, a sealing material and the like comprising a curable resin composition, in particular, an epoxy resin composition, are often used in assembling and mounting an electronic component used in a semiconductor device, such as a semiconductor chip, for such purposes as maintaining reliability. Semiconductor devices, especially image sensor modules used as camera modules for mobile phones and smartphones, comprise components that degrade under high temperature conditions, such as lenses, so the manufacturing process must be carried out under low temperature conditions. The adhesives and sealing materials used in the manufacture of image sensor modules are, therefore, required to exhibit sufficient curability even under low temperature conditions. At the same time, they are required to be curable in a short time from the perspective of production costs. Since they are also used to prevent moisture from penetrating into electronic components, they are further required to show sufficient moisture resistance.

An epoxy resin composition used for an adhesive and a sealing material for electronic components (hereinafter, sometimes referred to simply as a “curable composition”) typically comprises an epoxy resin and a curing agent. Epoxy resins include a variety of polyfunctional epoxy resins, i.e., epoxy resins having two or more epoxy groups. Curing agents include compounds having two or more functional groups that react with the epoxy groups in the epoxy resins. Among such curable compositions, those that use a thiol-based curing agent as a curing agent are known to cure in a reasonably short time even under low temperature conditions (Patent Documents 1 and 2). Thiol-based curing agents include compounds having two or more thiol groups, i.e., polyfunctional thiol compounds. Known examples of polyfunctional thiol compounds conventionally used as curing agents in curable compositions for electronic components include pentaerythritol tetrakis(3-mercaptopropionate), trimethylolpropane tris(3-mercaptopropionate), pentaerythritol tetrakis(3-mercaptobutyrate) and the like. However, curable compositions that use such curing agents had a problem of giving cured products having insufficient moisture resistance, and there has been a desire to solve this problem.

This inadequate moisture resistance is believed to be attributable to the fact that many conventional polyfunctional thiol compounds have hydrolyzable substructures such as ester bonds. In particular, ester bonds are easily hydrolyzed in high temperature and high humidity environments, and this is likely to result in the cured product having reduced moisture resistance. It has been proposed, therefore, to use a polyfunctional thiol compound having no hydrolyzable substructures (a non-hydrolyzable thiol compound) as the curing agent for curable compositions to improve the moisture resistance of the obtained cured product.

For example, Patent Document 3 discloses polyfunctional thiol compounds that are used as curing agents in curable compositions, and specific examples include 1,3,4,6-tetrakis(2-mercaptoethyl)glycoluril, 1,3,4,6-tetrakis(3-mercaptopropyl)glycoluril, and the like. These are also described in Patent Document 4.

Further, Patent Document 5 discloses polyfunctional thiol compounds that are used as curing agents in curable compositions, and specific examples of the compounds include pentaerythritol tripropanethiol and the like.

All of these polyfunctional thiol compounds are non-hydrolyzable thiol compounds, which have no hydrolyzable substructures. A curable composition that uses a thiol-based curing agent comprising a non-hydrolyzable thiol compound cures in a moderately short time even under low temperature conditions, as does a curable composition that uses a conventional thiol-based curing agent. Further, the cured product provided by the former curable composition has improved moisture resistance as compared with that provided by the latter curable composition.

### PRIOR ART DOCUMENTS

### Patent Documents

Patent Document 1: Japanese Patent Application Laid-Open No. Hei 06-211969

Patent Document 2: Japanese Patent Application Laid-Open No. Hei 06-211970

Patent Document 3: Japanese Patent Application Laid-Open No. 2017-031268

Patent Document 4: Japanese Patent Application Laid-Open No. 2016-16975

Patent Document 5: WO 2016/171072

### SUMMARY OF THE INVENTION

### Problems to be Solved by the Invention

The present inventors have found, however, that use of non-hydrolyzable thiol compounds results in a curable composition that shows an excessive increase in viscosity, making it difficult to apply or inject it into the application site. This high viscosity is attributed to the highly polar structure of non-hydrolyzable thiol compounds. For example, 1,3,4,6-tetrakis(2-mercaptoethyl)glycoluril, mentioned above, has a chemical structure in which two highly polar urea bonds (—N—(C═O)—N—) are contained in a relatively small scaffold. Such a structure is responsible for the very high polarity of 1,3,4,6-tetrakis(2-mercaptoethyl)glycoluril and hence the excessively increased viscosity of the curable composition as a whole.

If a low viscosity epoxy resin is used to reduce the viscosity of the curable composition as a whole, it causes separation of components, making it impossible to obtain a homogeneous curable composition. This is due to the low polarity chemical structures commonly found in low viscosity epoxy resins and the high polarity of non-hydrolyzable thiol compounds, resulting in low compatibility between the two.

Accordingly, an objective of the present invention is to provide an epoxy resin composition that cures in a short time even under low temperature conditions to give a cured product having excellent moisture resistance and that is low in viscosity and can be easily applied to or injected into an application site, as well as a sealing material comprising the same.

### Solution to the Problems

Under these circumstances, the present inventors carried out intensive research to develop a curable composition that not only cures in a short time under low temperature conditions to give a cured product with excellent moisture resistance but also is low in viscosity and can be easily applied to or injected into an application site, and that, in addition, is homogeneous and does not suffer from separation of components. As a result, it has been surprisingly found that a homogeneous curable composition can be obtained by combining a thiol-based curing agent comprising a specific non-hydrolyzable polyfunctional thiol compound with a main epoxy resin consisting of a main aliphatic polyfunctional epoxy resin having a specific chemical stricture and a curing catalyst, and that the aforementioned components do not separate from this composition. The present inventors have further found that this curable composition cures in a short time even under low temperature conditions to give a cured product having excellent moisture resistance, and that this curable composition shows a low viscosity at 25° C. of 3 Pa·s or lower, allowing the curable composition to be easily applied to or injected into an application site. Based on the new findings above, the present invention has been completed.

That is, the present invention includes, but is not limited to, the following inventions.

1. An epoxy resin composition comprising components (A) to (C) below:

(A) at least one thiol-based curing agent comprising a non-hydrolyzable polyfunctional thiol compound having at least one hydroxyl group and/or urea bond;

(B) a main epoxy resin consisting of at least one main aliphatic poly-functional epoxy resin selected from the group consisting of components (B-1) to (B-3) below:
(B-1) a polyethylene glycol diglycidyl ether,
(B-2) a cyclohexane-based diglycidyl ether, and
(B-3) a dicyclopentadiene-based diglycidyl ether; and

(C) a curing catalyst;

the epoxy resin composition having a viscosity at 25° C. of 0.05 Pa·s or higher and 3 Pa·s or lower.

2. The epoxy resin composition according to preceding item 1, wherein the non-hydrolyzable polyfunctional thiol compound is a compound having no ester bond.

3. The epoxy resin composition according to preceding item 1 or 2, wherein the non-hydrolyzable polyfunctional thiol compound is a compound represented by formula (1) below:

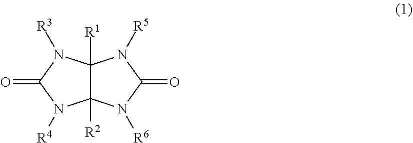

wherein
R¹ and R² are, each independently, selected from the group consisting of a hydrogen atom, an alkyl group having 1 to 12 carbon atoms, and a phenyl group; and
R³, R⁴, R⁵ and R⁶ are, each independently, selected from the group consisting of a mercaptomethyl group, a mercaptoethyl group and a mercaptopropyl group.

4. The epoxy resin composition according to preceding item 3, wherein the compound represented by formula (1) is 1,3,4,6-tetrakis(2-mercaptoethyl)glycoluril and/or 1,3,4,6-tetrakis(3-mercaptopropyl)glycoluril.

5. The epoxy resin composition according to preceding item 1 or 2, wherein the non-hydrolyzable polyfunctional thiol compound is a compound represented by formula (2) below:

(R⁸)ₘ-A-(R⁷—SH)ₙ (2)

wherein
A is a residue of a polyhydric alcohol having n m hydroxyl groups, and comprises n+m oxygen atoms derived from the hydroxyl groups,
R⁷ is each, independently, an alkylene group having 1 to 10 carbon atoms,
R⁸ is each, independently, a hydrogen atom or an alkyl group having 1 to 10 carbon atoms,
m is an integer equal to or greater than 0,
n is an integer equal to or greater than 2,
wherein R¹ and R² are each bonded to A via one of the oxygen atoms.

6. The epoxy resin composition according to any one of preceding items 1 to 5, further comprising an auxiliary epoxy resin (B′) comprising at least one selected from the group consisting of:

(B′-1) at least one auxiliary aliphatic polyfunctional epoxy resin which is an aliphatic polyfunctional epoxy resin other than the main aliphatic polyfunctional epoxy resin, and

(B′-2) at least one aromatic polyfunctional epoxy resin.

7. The epoxy resin composition according to any one of preceding items 1 to 6, further comprising a monofunctional epoxy resin.

8. The epoxy resin composition according to any one of preceding items 1 to 7, wherein the component (B) has a viscosity at 25° C. of 0.3 Pa·s or lower.

9. The epoxy resin composition according to any one of preceding items 1 to 8, wherein the component (C) is a latent curing catalyst.

10. A sealing material or an adhesive comprising the epoxy resin composition according to any one of preceding items 1 to 9.

11. A cured product obtained by curing the epoxy resin composition according to any one of preceding items 1 to 9 or the sealing material or the adhesive according to preceding item 10.

12. An electronic component comprising the cured product according to preceding item 11.

### DESCRIPTION OF EMBODIMENTS

Hereinafter, the present invention will be described in detail.

As described above, the epoxy resin composition (curable composition) of the present invention comprises a thiol-based curing agent (component (A)), a main epoxy resin (component (B)) and a curing catalyst (component (C)) as essential components, and, optionally, further comprises an auxiliary epoxy resin (component (B′)). These components (A) to (C) and (B′) will be described below.

Following conventional usage in the field of epoxy resins, terms containing the term “resin,” which under normal circumstances refers to a polymer (in particular, a synthetic polymer), may be used herein to refer to a component constituting an uncured epoxy resin composition, even if the component is not a polymer.

(1) Thiol-Based Curing Agent (Component (A))

The thiol-based curing agent (component (A)) used in the present invention comprises a non-hydrolyzable polyfunctional thiol compound having at least one hydroxyl group and/or urea bond. As described above, this non-hydrolyzable polyfunctional thiol compound is a compound having two or more thiol groups that react with the epoxy groups in the epoxy resins (components (B) and (B′)) or the monofunctional epoxy resin (optional component) described below and which has no hydrolyzable substructure. This compound further comprises one or more hydroxyl groups and/or urea bonds.

Since conventional thiol-based curing agents comprise polyfunctional thiol compounds having hydrolyzable substructures such as ester bonds, the cured product given by a curable composition obtained using a conventional thiol-based curing agent undergoes hydrolysis of such a substructure especially in high temperature and high humidity environments and shows insufficient moisture resistance. By contrast, the component (A) described above, which comprises a non-hydrolyzable polyfunctional thiol compound, does not hydrolyze even in a high temperature and high humidity environment, with the result that the cured product given by a curable composition obtained using this component shows greatly improved moisture resistance.

A hydrolyzable substructure refers to a substructure that can be hydrolyzed under relatively mild conditions, and examples thereof include ester bonds. Such a substructure is, by its very nature, even more susceptible to hydrolysis under severe conditions, for example, in high temperature and high humidity environments. On the other hand, hydrolyzable substructures do not include substructures that can only be hydrolyzed under extremely severe conditions. Urea bonds, for example, may theoretically be hydrolyzed, but in practice, the urea bonds in urea bond-containing compounds, such as 1,3,4,6-tetrakis(2-mercaptoethyl)glycoluril, can only be hydrolyzed under extremely severe conditions. The non-hydrolyzable polyfunctional thiol compound used in the present invention is preferably a compound having no ester bond.

Preferable non-hydrolyzable polyfunctional thiol compounds that may be used in the present invention are compounds represented by formula (1) below:

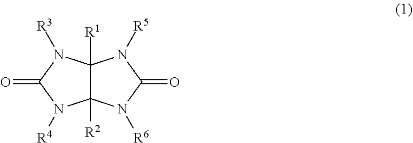

wherein
R¹ and R² are, each independently, selected from the group consisting of a hydrogen atom, an alkyl group having 1 to 12 carbon atoms and a phenyl group; and
R⁴, R⁵ and R⁶ are, each independently, selected from the group consisting of a mercaptomethyl group, a mercaptoethyl group and a mercaptopropyl group.
   Examples of compounds represented by formula (1) include, in addition to above-mentioned 1,3,4,6-tetrakis(2-mercaptoethyl)glycoluril (trade name: TS-G, manufactured by Shikoku Chemicals Corporation) and 1,3,4,6-tetrakis(3-mercaptopropyl)glycoluril (trade name: C3 TS-G, manufactured by Shikoku Chemicals Corporation), 1,3,4,6-tetrakis(mercaptomethyl)glycoluril, 1,3,4,6-tetrakis(mercaptomethyl)-3a-methylglycoluril, 1,3,4,6-tetrakis(2-mercaptoethyl)-3a-methylglycoluril, 1,3,4,6-tetrakis(3-mercaptopropyl)-3a-methylglycoluril, 1,3,4,6-tetrakis(mercaptomethyl)-3a, 6a-dimethylglycoluril, 1,3,4,6-tetrakis(2-mercaptoethyl)-3a,6a-dimethylglycoluril, 1,3,4,6-tetrakis(3-mercaptopropyl)-3a,6a-dimethylglycoluril, 1,3,4,6-tetrakis(mercaptomethyl)-3a,6a-diphenylglycoluril, ,3,4,6-tetrakis(2-mercaptoethyl)-3a,6a-diphenylglycoluril, 1,3,4,6-tetrakis(3-mercaptopropyl)-3a,6a-diphenylglycoluril and the like. These may be used alone or in an admixture of two or more. Among these, 1,3,4,6-tetrakis(2-mercaptoethyl)glycoluril and 1,3,4,6-tetrakis(3-mercaptopropyl)glycoluril are particularly preferable.

Other preferable non-hydrolyzable polyfunctional thiol compounds that may be used in the present invention are compounds represented by formula (2) below:

(R⁸)ₘ-A-(R⁷—SH)ₙ (2)

wherein
A is a residue of a polyhydric alcohol having n+m hydroxyl groups, and comprises n+m oxygen atoms derived from the hydroxyl groups,
R⁷ is each, independently, an alkylene group having 1 to 10 carbon atoms,
R⁸ is each, independently, a hydrogen atom or an alkyl group having 1 to 10 carbon atoms,
m is an integer greater than or equal to 0,
n is an integer greater than or equal to 2,
R⁷ and R⁸ are each bonded to A via one of the oxygen atoms.
   Two or more compounds represented by formula (2) may be used in combination. Examples of compounds represented by formula (2) include pentaerythritol tripropanethiol (trade name: PEPT, manufactured by SC Organic Chemical Co., Ltd.) as well as trimethylolpropane dipropanethiol and the like. Of these, pentaerythritol tripropanethiol is particularly preferred.

Particularly preferably, component (A) is free of hydrolyzable polyfunctional thiol compounds, which are used conventionally, but it may also comprise them to the extent that they do not undermine the purpose of the present invention. The amount of hydrolyzable polyfunctional thiol compounds in component (A) is less than 100 parts by mass, preferably less than 70 parts by mass, and more preferably less than 50 parts by mass, relative to 100 parts by mass of non-hydrolyzable polyfunctional thiol compounds. When the amount of hydrolyzable polyfunctional thiol compounds is 100 parts by mass or greater, the cured product given by the epoxy resin composition of the present invention shows insufficient moisture resistance,

(2) Main Epoxy Resin (Component (B))

The main epoxy resin (component (B)) used in the present invention consists of at least one main aliphatic polyfunctional epoxy resin selected from the group consisting of components (B-1) to (B-3) below:

(B-1) a polyethylene glycol diglycidyl ether,

(B-2) a cyclohexane-based diglycidyl ether, and

(B-3) a dicyclopentadiene-based diglycidyl ether.

Alternatively, in another embodiment of the present invention, the main epoxy resin (component (B)) used may consist of at least one main aliphatic polyfunctional epoxy resin selected from the group consisting of components (B-1) and (B-3) below:

(B-1) a polyethylene glycol diglycidyl ether, and

(B-3) a dicyclopentadiene-based diglycidyl ether.

As used herein, the term “cyclohexane-based diglycidyl ether” refers to a compound having a structure in which two glycidyl groups are bonded, each through an ether bond, to a divalent saturated hydrocarbon group having one cyclohexane ring as a parent structure.

As used herein, the term “dicyclopentadiene-based diglycidyl ether” refers to a compound having a structure in which two glycidyl groups are bonded, each through an ether bond, to a divalent saturated hydrocarbon group having a. dicyclopentadiene skeleton as a parent structure.

The use of a non-hydrolyzable polyfunctional thiol compound in the component (A) above is important in improving the moisture resistance of the cured product given by the epoxy resin composition of the present invention. However, as described above, curable compositions prepared using non-hydrolyzable polyfunctional thiol compounds have extremely high viscosities. Moreover, it is difficult to adjust the viscosities of such curable compositions using what is called a reactive diluent (an epoxy resin having a viscosity at 25° C. of 1 Pa·s or lower). These are all attributed to the highly polar structure of non-hydrolyzable polyfunctional thiol compounds. In this context, the present inventors explored a variety of means to reduce the viscosity of curable compositions prepared using non-hydrolyzable polyfunctional thiol compounds. As a result, it was found that this objective is achieved by using a main epoxy resin consisting of at least one main aliphatic polyfunctional epoxy resin selected from the group consisting of the above-mentioned components (B-1) to (B-3).

Since the main aliphatic polyfunctional epoxy resins described above are all low viscosity epoxy resins, they are effective in reducing the viscosities of curable compositions. As discussed above, most low-viscosity epoxy resins are low in polarity and are therefore poorly compatible with non-hydrolyzable thiol compounds. However, the main aliphatic polyfunctional epoxy resins described above exhibit sufficiently high compatibility with non-hydrolyzable thiol compounds. This is presumed to be due, at least in part, to the fact that the main aliphatic polyfunctional epoxy resins are somewhat high in polarity in relative terns among viscosity epoxy resins.

In the epoxy resin composition of the present invention, the ratio ([epoxy functional group equivalent quantity]/[thiol functional group equivalent quantity]) of the epoxy functional group equivalent quantity for component (B) above to the thiol functional group equivalent quantity for component (A) above is preferably 0.4 or greater and 1.2 or less.

Thiol functional group equivalent quantity refers to the total number of thiol groups in the thiol compound contained in the component or composition of interest, and is the quotient of the mass (g) of the thiol compound contained in the component or composition of interest divided by the thiol equivalent weight of the thiol compound (if a plurality of thiol compounds are present, the sum of such quotient for each thiol compound). The thiol equivalent weight of a thiol compound is the quotient of the molecular weight of the thiol compound divided by the number of thiol groups per molecule of the thiol compound. If thiol equivalent weight cannot be calculated using this method, the thiol equivalent weight can be determined, for example, by a method that involves determining the thiol value of the thiol compound by potentiometry.

Epoxy functional group equivalent quantity refers to the total number of epoxy groups in the epoxy resin (components (B) and (B′) above and the monofunctional epoxy resin) contained in the component or composition, and is the quotient of the mass (g) of the epoxy resin contained in the component or composition of interest divided by the epoxy equivalent weight of the epoxy resin (if a plurality of epoxy resins are present, the sum of such quotient for each epoxy resin). The epoxy equivalent weight of an epoxy resin is the quotient of the molecular weight of the epoxy resin divided by the number of epoxy groups per molecule of the epoxy resin.

As a result of the use of component (B) as described above, the epoxy resin composition of the present invention exhibits a low viscosity at 25° C. of 0.05 Pa·s or higher and 3 Pa·s or lower. The viscosity of the epoxy resin composition of the present invention is preferably 0.3 Pa·s or lower at 25° C.

The component (B-1) above, a polyethylene glycol diglycidyl ether, has a structure in which the hydroxyl groups at both ends of polyethylene glycol are glycidylated. Therefore, there is a distribution in the number of repeating units contained therein, and those that are preferable among those falling under the component (B-1) above can be specified by the average number of repeating units thereof, that is, the average degree of polymerization thereof. The average degree of polymerization for the component (B-1) above is preferably 5 to 14, and more preferably 8 to 10.

The component (B-2) above, a cyclohexane-based diglycidyl ether, is not particularly limited and includes a variety of structures as long as it has a structure in which two glycidyl groups are bonded, each through an ether bond, to a divalent saturated hydrocarbon group having one cyclohexane ring as a parent structure. It is particularly preferred that the component (B-2) above is 0 represented by formula (3) below.

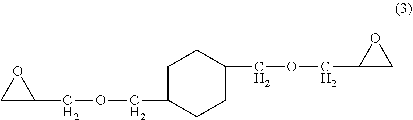 [SMILES: C1CC(COCC2CO2)CCC1COCC1CO1]

The component (B-3) above, a dicyclopentadiene-based diglycidyl ether, is not particularly limited and includes a variety of structures as long as it has a structure in which two glycidyl groups are bonded, each through an ether bond, to a divalent saturated hydrocarbon group having a dicyclopentadiene skeleton as a parent structure. The component (B-3) above is particularly preferably a dicyclopentadiene dimethanol diglycidyl ethers (CAS Number: 50985-55-2) represented by formula (4) below.

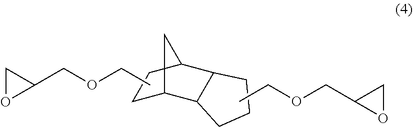

(2′) Auxiliary Epoxy Resin (Component (B′))

The main epoxy resin (component (B)) above may be the only epoxy resin used in the present invention, but the component (B) above may, if desired, be used in combination with another epoxy resin, i.e., an auxiliary epoxy resin (component (B′)), to the extent that the purpose of the present invention is not undermined. Component (B′) comprises at least one selected from the group consisting of (B′-1) to (B′-2) below:

(B′-1) at least one auxiliary aliphatic polyfunctional epoxy resin, and

(B′-2) at least one aromatic polyfunctional epoxy resin.

The auxiliary aliphatic polyfunctional epoxy resin (component (B′-1)) refers to an aliphatic polyfunctional epoxy resin that does not fall under any of the components (B-1) to (B-3) above, which constitute the main epoxy resin (component (B)). Since aliphatic polyfunctional epoxy resins such as component (B′-1) are typically lower in viscosity than aromatic polyfunctional epoxy resins (and thus qualify as low viscosity epoxy resins), the viscosity of the epoxy resin composition of the present invention can be adjusted by the addition of component (B′-1). However, since component (B′-1) shows low compatibility with non-hydrolyzable thiol compounds, excessive use thereof results in an inability to obtain a homogeneous curable composition.

Examples of component (B′-1) include, but are not limited to:
diepoxy resins such as (poly)propylene glycol diglycidyl ether, butanediol diglycidyl ether, neopentyl glycol diglycidyl ether, 1,6-hexanediol diglycidyl ether, trimethylolpropane diglycidyl ether, polytetramethylene ether glycol diglycidyl ether, glycerin diglycidyl ether, and neopentyl glycol diglycidyl ether;
triepoxy resins such as trimethylolpropane triglycidyl ether, and glycerin triglycidyl ether;
cycloaliphatic epoxy resins such as vinyl (3,4-cyclohexene)dioxide, and 2-(3,4-epoxycyclohexyl)-5,1-spiro-(3,4-epoxycyclohexyl)-m-dioxane;
glycidylamine-based epoxy resins such as tetraglycidyl bis(aminomethyl)cyclohexane;
hydantoin-based epoxy resins such as 1,3-diglycidyl-5-methyl-5-ethylhydantoin; and
epoxy resins having a silicone backbone such as 1,3-bis(3-glycidoxypropyl)-1,1,3,3-tetramethyldisiloxane.

Particularly preferably, the auxiliary aliphatic polyfunctional epoxy resin of component (B′-1) has a molecular weight of from 150 to 800.

The aromatic polyfunctional epoxy resin above (component (B′-2)) is a polyfunctional epoxy resin having a structure comprising an aromatic ring such as a benzene ring. Many conventional and commonly used epoxy resins, such as bisphenol A epoxy resins, are of this type. Since component (B′-2) is typically higher in viscosity than aliphatic polyfunctional epoxy resins and therefore cannot be used in order to adjust the viscosity of the epoxy resin composition of the present invention. However, some types of component (B′-2) shows high compatibility with non-hydrolyzable thiol compounds, and component (B′-2) of such types can be added for the purpose of maintaining the homogeneity of the epoxy resin composition.

Examples of component (B′-2) include, but are not limited to:
bisphenol A-based epoxy resins;
branched polyfunctional bisphenol A-based epoxy resins such as p-glycidyloxyphenyidimethyl trisbisphenol A diglycidyl ether;
bisphenol F-based epoxy resins;
novolac-based epoxy resins;
tetrabromobisphenol A-based epoxy resins;
fluorene-based epoxy resins;
biphenyl aralkyl epoxy resins;
diepoxy resins such as p-tert-butylphenyl glycidyl ether, and 1,4-phenyldimethanol diglycidyl ether;
biphenyl-based epoxy resins such as 3,3′,5,5′-tetramethyl-4,4′-diglycidyloxybiphenyl;
glycidylamine-based epoxy resins such as diglycidylaniline, diglycidyltoluidine, triglycidyl-p-aminophenol, tetraglycidyl-m-xylylenediamine; and
naphthalene ring-containing epoxy resins.

Particularly preferably, the aromatic polyfunctional epoxy resin of component (B′-2) has a molecular weight of from 200 to 400.

As will be discussed below, it is preferable that in the epoxy resin composition of the present invention, the epoxy groups of components (B) and (B′) above (as well as the monofunctional epoxy resin described below, if used) are present in an amount approximately equivalent to the thiol groups of component (A) above. If component (B) above is used in an amount such that its epoxy groups are present in an amount approximately equivalent to the thiol groups of component (A) above, component (B′) above is not necessarily used. Alternatively, however, it is possible to add component (B′) above so that the epoxy groups of components (B) and (B′) above are present in an amount approximately equivalent to the thiol groups of component (A) above. In this case, the viscosity of the epoxy resin composition can be adjusted while maintaining its homogeneity by appropriately adjusting the amounts added of component (B′-1) above, which has low viscosity, and component (B′-2), which shows high compatibility with non-hydrolyzable thiol compounds.

In the present invention, when component (B′) above comprises component (B′-2) above, the mass of component (B′-2) above is preferably less than 50%, more preferably less than 30%, of the total mass of components (B) and (B′) above. This is because an excessive amount of component (B′-2) results in high viscosity. In the present invention, for the purpose of realizing low viscosity, the total mass of the aliphatic polyfunctional epoxy resins (components (B) and (B′-1) above) is preferably 50% or greater, more preferably 60% or greater, and even more preferably 65% or greater, of the total mass of all the polyfunctional epoxy resins. It should be noted that these masses of epoxy resins refer to masses that include epoxy resins contained in component (C), which is described below.

(3) Curing Catalyst (Component (C))

The curing catalyst (component (C)) used in the present invention is not particularly limited as long as it serves as a curing catalyst for epoxy resins (components (B) and (B′) above), and those known in the art may be used, but the curing catalyst is preferably a latent curing catalyst. A latent curing catalyst is a compound that is inactive at room temperature and is activated upon heating to function as a curing catalyst, and examples include imidazole compounds that are solid at room temperature; solid dispersion-type amine adduct-based latent curing catalysts such as a reaction product of an amine compound and an epoxy compound (an amine-epoxy adduct system); a reaction product of an amine compound and an isocyanate compound or a urea compound (a urea adduct system); and the like. The use of component (C) above allows the epoxy resin composition of the present invention to be cured in a short time even under low temperature conditions.

Examples of imidazole compounds that are solid at room temperature include, but are not limited to, 2-heptadecyl imidazole, 2-phenyl-4,5-dihydroxymethyl imidazole, 2-undecyl imidazole, 2-phenyl-4-methyl-5-hydroxymethyl imidazole, 2-phenyl-4-benzyl-5-hydroxymethyl imidazole, 2,4-diamino-6-(2-methylimidazolyl-(1))-ethyl-s-triazine, an isocyanuric acid adduct of 2,4-diamino-6-(2′-methylimidazolyl-(1)′)-ethyl-s-triazine, 2-methylimidazole, 2-phenylimidazole, 2-phenyl-4-methylimidazole, 1-cyanoethyl-2-phenylimidazole, 1-cyanoethyl-2-methylimidazole-trimellitate, 1-cyanoethyl-2-phenylimidazole-trimellitate, N-(2-methylimidazolyl-1-ethyl)-urea, N,N′-(2-methylimidazolyl-(1)-ethyl)-adipoyldiamide and the like.

Typical examples of commercially available latent curing catalyst products include, but are not limited to, amine-epoxy adduct-based products (amine adducts) such as Ajicure PN-23 (trade name; Ajinomoto Fine-Techno Co., Inc.), Ajicure PN-40 (trade name; Ajinomoto Fine-Techno Co., Inc.), Ajicure PN-50 (trade name; Ajinomoto Fine-Techno Co., Inc.), Hardner X-36615 (trade name; A.C.R. (K.K.)), Hardner X-3670S (trade name; A.C.R (K.K.)), Novacure HX-3742 (trade name; Asahi Kasei Corp.), Novacure HX-3721 (trade name; Asahi Kasei Corp.), Novacure HXA9322HP (trade name; Asahi Kasei Corp.), Novacure HXA3922HP (trade name; Asahi Kasei Corp.), Novacure HXA3932HP (trade name; Asahi Kasei Corp.), Novacure HXA5945HP (trade name; Asahi Kasei Corp.), Novacure HXA9382HP (trade name; Asahi Kasei Corp.), and Fujicure FXR1121 (trade name; T & K TOKA Co., Ltd.) and the like; and urea adduct products such as Fujicure FXE-1000 (trade name; T & K TOKA Co., Ltd.), Fujicure FXR-1030 (trade name; T & K TOKA Co., Ltd.) and the like. Component (C) may be used alone or in combination of two or more kinds. For component (C), a solid dispersion-type amine adduct-based latent curing catalyst is preferable from the perspectives of pot life and curability.

Component (C) may be provided in the form of a dispersion dispersed in an epoxy resin (in particular, component (B′) above). It should be noted that, when component (C) is used in such form, the amount of the epoxy resin in which it is dispersed is also included in the amount of component (B) and/or (B′) above present in the epoxy resin composition of the present invention.

The epoxy resin composition of the present invention may comprise optional components other than components (A) to (C) described above, for example, those described below, if desired.

Monofunctional Epoxy Resin

The epoxy resin composition of the present invention may, if desired, comprise a monofunctional epoxy resin. A monofunctional epoxy resin is an epoxy resin having one epoxy group, and has conventionally been used as a reactive diluent for adjusting the viscosity of an epoxy resin composition. For this reason, the monofunctional epoxy resin preferably has low viscosity. As discussed above, monofunctional epoxy resins used as reactive diluents are not necessarily sufficiently compatible with non-hydrolyzable thiol compounds, and a suitable monofunctional epoxy resin should, therefore, be selected.

Examples of monofunctional epoxy resins include n-butyl glycidyl ether, 2-ethylhexyl glycidyl ether, phenyl glycidyl ether, cresyl glycidyl ether, p-s-butylphenyl glycidyl ether, styrene oxide, α-pinene oxide, allyl glycidyl ether, 1-vinyl-3,4-epoxycyclohexane, 1,2-epoxy-4-(2-methyloxiranyl)-1-methylcyclohexane, 4-tert-butylphenyl glycidyl ether, 1,3-bis(3-glycidoxypropyl)-1,1,3,3-tetramethyldisiloxane, neodecanoic acid glycidyl ester and the like. Among these, 1,2-epoxy-4-(2-methyloxiranyl)-1-methylcyclohexane and 4-tert-butylphenyl glycidyl ether are preferable and 4-tert-butylphenyl glycidyl ether is particularly preferable.

Particularly preferably, the monofunctional epoxy resin has a molecular weight of from 100 to 250.

The epoxy resin composition of the present invention may optionally comprise component (B′) above and this monofunctional epoxy resin, in addition to component (B) above, which is an essential component, and the total number (amount) of epoxy groups contained therein is preferably approximately equivalent to that of the thiol groups in component (A) above. More specifically, in the epoxy resin composition of the present invention, the ratio ([thiol functional group equivalent quantity]/[epoxy functional group equivalent quantity]) of the thiol functional group equivalent quantity to the epoxy functional group equivalent quantity is preferably 0.5 or greater and 2.0 or less, more preferably, 0.8 or greater and 1.2 or less. Here, [thiol functional group equivalent quantity] refers to the thiol functional group equivalent quantity of component (A) above. Also, [epoxy functional group equivalent quantity] refers to the total epoxy functional group equivalent quantity for the components that exist out of component (B) above, component (B′) above and the monofunctional epoxy resin.

For both epoxy groups and thiol groups in the composition, this results in the proportion of those involved in the reaction between epoxy groups and thiol groups, i.e., in the formation of intermolecular cross-links, being above a certain level, thereby making it possible to obtain a strong cured product having an appropriate cross-link density and to allow increased adhesive strength. If the above-mentioned ratio between functional group equivalent quantities is less than 0.5, it translates to there being a large excess of epoxy groups relative to thiol groups, leading to the progression of the reaction between the excessive epoxy groups (homopolymerization), in addition to the reaction between epoxy groups and thiol groups. This results in the formation, through both of these reactions, of intermolecular cross-links in the resulting cured product, leading to an excessively high cross-link density and a lowered adhesive strength. On the other hand, if the above-mentioned ratio between functional group equivalent quantities exceeds 2.0, it translates to there being a large excess of thiol groups relative to epoxy groups, leading to an insufficient number of formed intermolecular cross-links and hence an excessively low cross-link density. This, in turn, means that bleeding is more likely to occur on the surface of the cured product and that its adhesive strength is reduced.

Stabilizer

The epoxy resin composition of the present invention may, if desired, comprise a stabilizer. A stabilizer may be added to the epoxy resin composition of the present invention to improve its storage stability and to prolong its pot life. Various stabilizers known in the art as stabilizers for one-part epoxy-based adhesives may be used, and at least one selected from the group consisting of a liquid borate ester compound, an aluminum chelate, and an organic acid is preferable because of their high effectiveness in improving storage stability.

Examples of liquid borate ester compounds include 2,2′-oxybis(5,5′-dimethyl-1,3,2-oxaborinane), trimethyl borate, triethyl borate, tri-n-propyl borate, triisopropyl borate, tri-n-butyl borate, tripentyl borate, triallyl borate, trihexyl borate, tricyclohexyl borate, trioctyl borate, trinonyl borate, tridecyl borate, tridodecyl borate, trihexadecyl borate, trioctadecyl borate, tris(2-ethylhexyloxy)borane, bis(1,4,7,10-tetraoxaundecyl) (1,4,7,10,13-pentaoxatetradecyl) (1,4,7-trioxaundecyl)borane, tribenzyl borate, triphenyl borate, tri-o-tolyl borate, tri-m-tolyl borate, triethanolamine borate and the like. A liquid borate ester compound is preferable, because it is liquid at room temperature (25° C.) and therefore allows the viscosity of a mixture comprising it to be kept low. Examples of aluminum chelates that may be used include aluminum chelate A. Examples of organic acids that may be used include barbituric acid.

If an stabilizer is added, the amount added is preferably 0.01 to 30 parts by mass, more preferably 0.05 to 25 parts by mass, and still more preferably 0.1 to 20 parts by mass with respect to 100 parts by mass of the total amount of components (A) to (C).

Filler

The epoxy resin composition of the present invention may, if desired, comprise a filler. If the epoxy resin composition of the present invention is used as a one-part adhesive, the addition of a filler thereto improves the moisture resistance and the thermal cycling resistance, especially the thermal cycling resistance, of the adhered region. The reason the addition of a filler improves thermal cycling resistance is because it decreases the coefficient of linear expansion of the cured product, that is, it suppresses the expansion and contraction of the cured product induced by thermal cycling.

There are no particular limitations on the filler as long as it has an effect of reducing the coefficient of linear expansion, and various fillers can be used. Specific examples of fillers include a silica filler, an alumina filler, a talc filler, a calcium carbonate filler, a polytetrafluoroethylene (PTFE) tiller, and the like. Among these, a silica filler is preferable because it is conducive to high filler content.

If a filler is added, the proportion of the filler in the epoxy resin composition of the present invention is preferably from 5 to 80 mass %, more preferably from 5 to 65 mass %, and even more preferably from 5 to 50 mass %, of the entire epoxy resin composition.

Coupling Agent

The epoxy resin composition of the present invention may, if desired, comprise a coupling agent. The addition of a coupling agent, in particular, a silane coupling agent is preferable from the perspective of improving adhesive strength. As the coupling agent, various silane coupling agents may be used such as epoxy-based, amino-based, vinyl-based, methacrylic-based, acrylic-based, and mercapto-based coupling agents. Specific examples of silane coupling agents include 3-glycidoxypropyltrimethoxysilane, 3-aminopropyltrimethoxysilane, vinyltrimethoxysilane, 3-triethoxysilyl-N-(1,3-dimethyl-butylidene)propylamine, 2-(3,4-epoxycyclohexyl)ethyltrimethoxysilane, p-styryltrimethoxysilane, 3-methacryloxypropylmethyltrimethoxysilane, 3-acryloxypropyltrimethoxysilane, 8-glycidoxyoctyltrimethoxysilane, 3-ureidopropyltriethoxysilane, 3-mercaptopropyltrimethoxysilane, bis(triethoxysilylpropyl)tetrasulfide, 3-isocyanatopropyltriethoxysilane and the like. These silane coupling agents may be used alone or in combination of two or more kinds.

In the epoxy resin composition of the present invention, the amount of the coupling agent added is preferably from 0.01 to 50 parts by mass, more preferably from 0.1 to 30 parts by mass, with respect to 100 parts by mass of the total amount of components (A) to (C), from the perspective of improving adhesive strength.

Other Additives

The epoxy resin composition of the present invention may, if desired, comprise other additives such as carbon black, titanium black, an ion trapping agent, a leveling agent, an antioxidant, an antifoaming agent, an thixotropic agent, a viscosity adjusting agent, a flame retardant, coloring agent, a solvent, and the like insofar as they do not depart from the spirit of the present invention. The type and amount of each additive are in accordance with usual practice in the art.

There are no particular limitations on methods for producing the epoxy resin composition of the present invention. For example, the epoxy resin composition of the present invention may be obtained by introducing components (A) to (C) and, if desired, other additives into a suitable mixer simultaneously or separately, followed by stirring and mixing while, if necessary, heating and melting, to yield a homogeneous composition. There are no particular limitations on the mixer, and a Raikai mixer (grinder) equipped with a stirrer and a heater, a Henschel mixer, a three-roll mill, a ball mill, a planetary mixer, a bead mill, or the like can be used. These devices may be used in combination, as appropriate.

The epoxy resin composition thus obtained is thermosetting, and under conditions having a temperature of 80° C., cures preferably in 5 hours, and more preferably in 1 hour. It may also he cured at high temperatures in a very short time, for example, in several seconds at a temperature of 150° C. If the epoxy resin composition of the present invention is used in the manufacture of an image sensor module comprising components that deteriorate under high temperature conditions, it is preferable to thermally cure the composition at a temperature of 60 to 90° C. for 30 to 120 minutes, or to thermally cure the composition at a temperature of 120 to 200° C. for 1 to 300 seconds.

The epoxy resin composition of the present invention can be used, for example, as an adhesive, a sealing material or a dam agent for fixing, bonding or protecting a semiconductor device comprising various electronic components and parts constituting an electronic component, or as a raw material thereof. The epoxy resin composition of the present invention is particularly suitable for use as a filling material for protecting and fixing camera modules and electronic components.

In some cases, adhesives and sealing materials for electronic components may need to be injected into narrow regions, and the epoxy resin composition of the present invention is suitable for these applications because its viscosity can be lowered. In addition, the epoxy resin composition of the present invention gives a cured product having excellent moisture resistance. The cured products given by conventional curable compositions that use thiol-based curing agents had problems of inferior moisture resistance and of deteriorating in high temperature and high humidity environments. By contrast, the cured product given by the epoxy resin composition of the present invention does not deteriorate easily even in a high temperature and high humidity environment.

The present invention also provides a sealing material comprising the epoxy resin composition of the present invention. The sealing material of the present invention is suitable for use as, for example, a filling material for protecting or fixing a module, an electronic component, and the like.

The present invention also provides a cured product obtained by curing the epoxy resin composition or the sealing material of the present invention.

The present invention further provides an electronic component comprising the cured product of the present invention.

### EXAMPLES

Hereinafter, the present invention will be described by way of examples, but the present invention is not limited thereto. In the following examples, parts and percentages, unless otherwise specified, represent parts by mass and percentages by mass.

### Examples 1 to 13 and Comparative Examples 1 to 4

Epoxy resin compositions were prepared by mixing each of the components in the amounts according to the formulations shown in Tables 1 and 2 using a three-roll mill. In Tables 1 and 2, the amount of each component is expressed in parts by mass. The values in the parentheses represent the thiol functional group equivalent quantities (or the epoxy functional group equivalent quantities) for the corresponding thiol compounds (or epoxy resins). The ratios of the amount of the main epoxy resin to the total amount of the main epoxy resin and the auxiliary epoxy resin (component (B)/(component (B)+component (B′)) are expressed as ratios by mass.

Non-hydrolyzable Polyfunctional Thiol Compound (Component (A))

The following lists the compounds used as component (A) in the Examples and Comparative Examples.

(A-1): 1,3,4,6-tetrakis(2-mercaptoethyl)glycoluril (trade name: TS-G, manufactured by Shikoku Chemicals Corporation, thiol equivalent weight: 100)

(A-2): 1,3,4,6-tetrakis(3-mercaptopropyl)glycoluril (trade name: C3 TS-G, manufactured by Shikoku Chemicals Corporation, thiol equivalent weight: 114)

Main Epoxy Resin (Component (B))

The following lists the compounds used as component (B) in the Examples and Comparative Examples.

(B-1): polyethylene glycol glycidyl ether (average degree of polymerization: 9) (trade name: SR-8EGS, manufactured by Sakamoto Yakuhin Kogyo Co., Ltd., epoxy equivalent weight: 262)

(B-2): 1,4-cyclohexanedimethanol diglyeidyl ether (trade name: CDMDG, manufactured by Showa Denko K.K., epoxy equivalent weight: 133)

(B-3): dicyclopentadiene dimethanol diglycidyl ether (trade name: 4088L, manufactured by ADEKA Corporation, epoxy equivalent weight: 165)

Auxiliary Epoxy Resin (Component (B′))

The following lists the compounds used as component (B′) in the Examples and Comparative Examples.

(B′-1)1: 1,3-bis(3-glycidoxypropyl)-1,1,3,3-tetramethyldisiloxane (trade name: TSL9906, manufactured by Momentive Performance Materials Japan LLC, average molecular weight: 362, epoxy equivalent weight: 181)

(B′-1)-2: polypropylene glycol diglycidyl ether (average molecular weight: 640) (trade name: PG-207GS, manufactured by Nippon Steel & Sumitomo Metal Corporation, epoxy equivalent weight: 320)

(B′-2): bisphenol F-based epoxy resin (average molecular weight: 318) (trade name: YDF-8170, manufactured by Nippon Steel & Sumitomo Metal Corporation, epoxy equivalent weight: 159)

Curing Catalyst (Component (C))

The following lists the compounds used as component (C) in the Examples and Comparative Examples.

(C-1): amine-epoxy adduct-based latent curing catalyst 1 (trade name: Novacure HXA9322HP, manufactured by Asahi Kasci Corp.)

(C-2): amine-epoxy adduct-based latent curing catalyst 2 (trade name: Fujicure FXR1121, manufactured by T & K TOKA Co., Ltd.)

The curing catalyst (C-1) above is provided in the form of a dispersion liquid (latent curing catalyst/bisphenol A-based epoxy resin/bisphenol F-based epoxy resin=33/53/14 (mass ratio)) in which the latent curing catalyst in particulate form is dispersed in an epoxy resin (a mixture of a bisphenol A-based epoxy resin (epoxy equivalent weight: 180) and a bisphenol F-based epoxy resin (epoxy equivalent weight: 159)). The epoxy resins constituting this dispersion are treated as forming part of component (B′). In Tables 1 and 2, therefore, the row for component (C) shows the amount of the latent curing catalyst in (C-1) only, and the amount of epoxy resin in (C-1) is shown in a row for component (B′).

Monofunctional Epoxy Resin

In the Examples and Comparative Examples, p-tert-butylphenylglycidyl ether (trade name: ED-509S, manufactured, epoxy equivalent weight: 206) was used as the monofunctional epoxy resin.

Stabilizer and Filler

In the Examples and Comparative Examples, triisopropyl borate was used as a stabilizer and a silica filler was used as a filler.

In the Examples and Comparative Examples, the characteristics of the epoxy resin compositions were measured in the following manners.

<Compatibility>

The epoxy resin compositions prepared were visually examined and evaluated as a ◯ (good) if no clear separation of components was observed, Δ (acceptable) if observed to be in suspension, or × (poor) if a clear separation of components was observed.

<Viscosity>

The viscosities (unit: Pa·s) of the epoxy resin compositions were measured within 1 hour of their preparation using an E-type viscometer manufactured by Toki Sangyo Co., Ltd. (model number: TVE-22H, name of rotor: 1° 34′×R24) (set to a suitable measuring range (H, R or U)) at a rotor revolution speed of 10 rpm. Lower viscosity is preferable for ease of injection. The results are shown in Tables 1 and 2. Viscosity was not measured for the compositions the compatibilities of which were evaluated as ×. Those having a viscosity of 1 Pa·s or lower were evaluated as ⊚ (very good), those having a viscosity of over 1 Pa·s and 3 Pa·s or lower were evaluated as ◯ (good), and those having a viscosity of over 3 Pa·s were evaluated as × (poor).

TABLE 1

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Component (A) | (A-1) | 28 | 42 | 37 | | 27 | 28 | 28 | 28 |
| | | (0.28) | (0.42) | (0.37) | | (0.27) | (0.28) | (0.28) | (0.28) |
| | (A-2) | | | | 30 | | | | |
| | | | | | (0.26) | | | | |
| Component (B) | (B-1) | 67 | | | 65 | 71 | 67 | 67 | 67 |
| | | (0.26) | | | (0.24) | (0.27) | (0.26) | (0.26) | (0.26) |
| | (B-2) | | 53 | | | | | | |
| | | | (0.40) | | | | | | |
| | (B-3) | | | 58 | | | | | |
| | | | | (0.35) | | | | | |
| Component (B)′ | (B′-1)-1 | | | | | | | | |
| | (B′-1)-2 | | | | | | | | |
| | (B′-2) | | | | | | | | |
| | Epoxy resin | 3.35 | 3.35 | 3.35 | 3.35 | | 3.35 | 3.35 | 3.35 |
| | in (C-1) | (0.02) | (0.02) | (0.02) | (0.02) | | (0.02) | (0.02) | (0.02) |
| Component (C) | (C-1) | 1.65 | 1.65 | 1.65 | 1.65 | | 1.65 | 1.65 | 1.65 |
| | (Catalyst only) | | | | | | | | |
| | (C-2) | | | | | 2 | | | |
| Monofunctional epoxide | | | | | | | | | |
| Stabilizer | | | | | | | 0.1 | | |
| Filter | | 30 | 30 | 30 | 30 | 30 | 30 | | 50 |
| Total | | 130.0 | 130.0 | 130.0 | 130.0 | 130.0 | 130.1 | 100.0 | 150.0 |
| Component (B)/(Component (B) + | | 0.95 | 0.94 | 0.95 | 0.95 | 100 | 0.95 | 0.95 | 0.95 |
| Component (B′)) | | | | | | | | | |
| Epoxy functional group equivalent | | 0.91 | 0.95 | 0.95 | 0.94 | 1.00 | 0.91 | 0.91 | 0.91 |
| quantity for component (B)/thiol | | | | | | | | | |
| functional group equivalent | | | | | | | | | |
| quantity for component (A) | | | | | | | | | |
| Ratio of functional group equivalent | | 1.0 | 1.0 | 1.0 | 1.0 | 1.0 | 1.0 | 1.0 | 1.0 |
| quantities (for the entire curable | | | | | | | | | |
| composition) | | | | | | | | | |
| Results of | Compatibility | ◯ | ◯ | ◯ | ◯ | ◯ | ◯ | ◯ | ◯ |
| evaluation | Viscosity | ⊚ | ⊚ | ⊚ | ⊚ | ⊚ | ⊚ | ⊚ | ◯ |

TABLE 2

| | | | | | | | Compar- | Compar- | Compar- | Compar- |
|---|---|---|---|---|---|---|---|---|---|---|
| | | | | | | | ative | ative | ative | ative |
| | | Exam- | Exam- | Exam- | Exam- | Exam- | Exam- | Exam- | Exam- | Exam- |
| | | ple 9 | ple 10 | ple 11 | ple 12 | ple 13 | ple 1 | ple 2 | ple 3 | ple 4 |
| Component (A) | (A-1) | 36 | 36 | 36 | 32 | 23 | 35 | 24 | 32 | 38 |
| | | (0.36) | (0.36) | (0.36) | (0.32) | (0.23) | (0.35) | (0.24) | (0.32) | (0.38) |
| | (A-2) | | | | | | | | | |
| Component (B) | (B-1) | | | | 63 | 72 | | | | |
| | | | | | (0.24) | (0.27) | | | | |
| | (B-2) | 6 | | | | | | | | |
| | | (0.04) | | | | | | | | |
| | (B-3) | 17 | 39 | 33 | | | | | | 17 |
| | | (0.10) | (0.24) | (0.20) | | | | | | (0.10) |
| Component (B)′ | (B′-1)-1 | | 20 | 26 | | | 60 | | | |
| | | | (0.11) | (0.14) | | | (0.33) | | | |
| | (B′-1)-2 | | | | | | | 71 | | |
| | | | | | | | | (0.22) | | |
| | (B′-2) | 9 | | | | | | | | 40 |
| | | (0.06) | | | | | | | | (0.25) |
| | Epoxy resin | 3.35 | 3.35 | 3.35 | 3.35 | 3.35 | 3.35 | 3.35 | 3.35 | 3.35 |
| | in (C-1) | (0.02) | (0.02) | (0.02) | (0.02) | (0.02) | (0.02) | (0.02) | (0.02) | (0.02) |
| Component (C) | (C-1) | 1.65 | 1.65 | 1.65 | 1.65 | 1.65 | 1.65 | 1.65 | 1.65 | 1.65 |
| | (Catalyst only) | | | | | | | | | |
| | (C-2) | | | | | | | | | |
| Monofunctional epoxide | | 28 | | | | | | | 63 | |
| | | (0.14) | | | | | | | (0.30) | |
| Stabilizer | | | | | | | | | | |
| Filler | | 30 | 30 | 30 | 30 | 30 | 30 | 30 | 30 | 30 |
| Total | | 131.0 | 130.0 | 130.0 | 130.0 | 130.0 | 130.0 | 130.0 | 130.0 | 130.0 |
| Component (B)/(Component (B) + | | 0.65 | 0.95 | 0.95 | 0.95 | 0.96 | 0.95 | 0.95 | 0 | 0.28 |
| Component (B′)) | | | | | | | | | | |
| Epoxy functional group equivalent | | 0.41 | 0.65 | 0.55 | 0.75 | 1.19 | 0 | 0 | 0 | 0.27 |
| quantity for component (B)/thiol | | | | | | | | | | |
| functional group equivalent | | | | | | | | | | |
| quantity for component (A) | | | | | | | | | | |
| Ratio of functional group equivalent | | 1.0 | 1.0 | 1.0 | 1.2 | 0.8 | 1.0 | 1.0 | 1.0 | 1.0 |
| quantities (for the entire curable | | | | | | | | | | |
| composition) | | | | | | | | | | |
| Results of | Compatibility | ◯ | ◯ | Δ | ◯ | ◯ | X | X | X | ◯ |
| evaluation | Viscosity | ⊚ | ⊚ | ⊚ | ⊚ | ⊚ | — | — | — | X |

As can be seen from Tables 1 and 2, in all of Examples 1 to 13, the viscosity was as low as 3 Pa·s or lower, and no clear separation of components was observed. By contrast, in all of Comparative Examples 1 to 3, which did not comprise component (B), a clear separation of components was observed and it was not possible to obtain a homogeneous composition. Further, in Comparative Example 4, which only had a small amount of component (B), although a homogenous composition was obtained, the composition had a high viscosity of over 3 Pa·s.

### INDUSTRIAL APPLICABILITY

The epoxy resin composition of the present invention is very useful as an adhesive, sealing material, dam agent or the like for semiconductor devices and electronic components, because the epoxy resin composition cures in a short time even under low temperature conditions to give a cured product having excellent moisture resistance and has a low viscosity of 3 Pa·s or lower, thereby allowing it to be easily applied to or injected into an application site.

1. An epoxy resin composition comprising components (A) to (C) below:
(A) at least one thiol-based curing agent comprising a non-hydrolyzable polyfunctional thiol compound having at least one hydroxyl group and/or urea bond;
(B) a main epoxy resin consisting of at least one main aliphatic polyfunctional epoxy resin selected from the group consisting of components (B-1) to (B-3) below:
(B-1) a polyethylene glycol diglycidyl ether,
(B-2) a cyclohexane-based diglycidyl ether, and
(B-3) a dicyclopentadiene-based diglycidyl ether; and
(C) a curing catalyst;
wherein the epoxy resin composition has a viscosity at 25° C. of at least 0.05 Pa·s and not more than 3 Pa·s.

2. The epoxy resin composition according to claim 1, wherein the non-hydrolyzable polyfunctional thiol compound is a compound having no ester bond.

3. The epoxy resin composition according to claim 1, wherein the non-hydrolyzable polyfunctional thiol compound is a compound represented by formula (1) below: 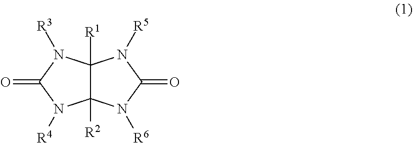
wherein:
R¹ and R² are, each independently, selected from the group consisting of a hydrogen atom, an alkyl group having 1 to 12 carbon atoms, and a phenyl group; and
R³, R⁴, R⁵ and R⁶ are, each independently, selected from the group consisting of a mercaptomethyl group, a mercaptoethyl group and a mercaptopropyl group.

4. The epoxy resin composition according to claim 3, wherein the compound represented by formula (I) is 1,3,4,6-tetrakis(2-mercaptoethyl)glycoluril and/or 1,3,4,6-tetrakis(3-mercaptopropyl)glycoluril.

5. The epoxy resin composition according to claim 1, wherein the non-hydrolyzable polyfunctional thiol compound is a compound represented by formula (2) below:
(R⁸)ₘ-A-(R⁷—SH)ₙ (2)
wherein:
A is a residue of a polyhydric alcohol having n+m hydroxyl groups, and comprises n+m oxygen atoms derived from the hydroxyl groups,
R⁷ is each, independently, an alkylene group having 1 to 10 carbon atoms,
R⁸ is each, independently, a hydrogen atom or an alkyl group having 1 to 10 carbon atoms,
m is an integer equal to or greater than 0,
n is an integer equal to or greater than 2,
wherein R⁷ and R⁸ are each bonded to A via one of the oxygen atoms.

6. The epoxy resin composition according to claim 1, further comprising an auxiliary epoxy resin (B′) comprising at least one selected from the group consisting of:
(B′-1) at least one auxiliary aliphatic polyfunctional epoxy resin which is an aliphatic polyfunctional epoxy resin other than the main aliphatic polyfunctional epoxy resin, and
(B′-2) at least one aromatic polyfunctional epoxy resin.

7. The epoxy resin composition according to claim 1, further comprising a monofunctional epoxy resin.

8. The epoxy resin composition according to claim 1, wherein the component (B) has a viscosity at 25° C. of 0.3 Pa·s or lower.

9. The epoxy resin composition according to claim 1, wherein the component (C) is a latent curing catalyst.

10. A sealing material or an adhesive comprising the epoxy resin composition according to claim 1.

11. A cured product obtained by curing the epoxy resin composition according to claim 1.

12. An electronic component comprising the cured product according to claim 11.

13. A cured product obtained by curing the sealing material or the adhesive according to claim 10.

14. An electronic component comprising the cured product according to claim 13.
